(19) United States
(12) Patent Application Publication
(10) Pub. No.: US 2026/0096516 A1
(43) Pub. Date: Apr. 9, 2026

(54) BALE HANDLER CONTROL SYSTEM FOR AN AGRICULTURAL HARVESTER

(71) Applicant: CNH Industrial America LLC, New Holland, PA (US)

(72) Inventors: Nicholas Shane, Andalusia, IL (US); Douglas J. Bollin, Port Byron, IL (US); Jason D. Wattonville, Alleman, IA (US); Jordan Beckhusen, McGregor, TX (US)

(21) Appl. No.: 19/352,741

(22) Filed: Oct. 8, 2025

Related U.S. Application Data
(60) Provisional application No. 63/704,829, filed on Oct. 8, 2024.

(51) Int. Cl. A01F 15/08

(52) U.S. Cl. CPC A01F 15/0833; A01F 15/0883; A01F 2015/0891

(57) ABSTRACT

A bale handler control system for a bale handler of an agricultural harvester includes a controller configured to control the bale handler to automatically discharge a bale from the agricultural harvester based on a programmable control scheme. The controller may control the bale handler to transition among a plurality of configurations to enable the automatic bale discharge process. The bale handler control system may automatically discharge the bale following completion of weighing of the bale. As such, an operator of the agricultural harvester may no longer be required to provide a manual command each time a bale is ready to be discharged during field operation

### CROSS-REFERENCE TO RELATED APPLICATION

This application claims priority from and the benefit of U.S. Provisional Application Ser. No. 63/704,829, entitled “BALE HANDLER CONTROL SYSTEM FOR AN AGRICULTURAL HARVESTER”, filed Oct. 8, 2024, which is hereby incorporated by reference in its entirety.

### BACKGROUND

The present disclosure relates generally to a bale handler control system for an agricultural harvester.

This section is intended to introduce the reader to various aspects of art that may be related to various aspects of the present disclosure, which are described and/or claimed below. This discussion helps to provide the reader with background information to facilitate a better understanding of the various aspects of the present disclosure. Accordingly, it should be understood that these statements are to be read in this light, and not as admissions of prior art.

Certain agricultural systems may be used for baling an agricultural product into bales. An agricultural harvester may include a baler that bales an agricultural product (e.g., hay, straw, cotton) into a bale, wraps the bale, and subsequently ejects the bale for further handling. The agricultural harvester may include systems for feeding the agricultural product into the baler, wrapping the bale, and ejecting the bale from the baler.

Once the bale is wrapped, the baler may eject the wrapped bale into a bale handler system designed for managing discharge of the wrapped bale onto the field. The bale handler system may include a weighing system that measures the weight of each bale and provides the measurement to the operator of the agricultural harvester (e.g., through a digital display). The operator of the agricultural system may, accordingly, provide inputs through a multi-function handle to discharge the bale at an appropriate location.

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In accordance with an embodiment of the present disclosure, a bale handler control system for a bale handler of an agricultural harvester includes a controller comprising a processor and memory. The controller is configured to control one or more actuators of the bale handler to discharge a bale from the agricultural harvester, where the one or more actuators drive one or more articulatable sections of the bale handler to establish a plurality of positions, by: receiving at least one sensor signal, where the at least one sensor signal comprises a first sensor signal indicative of completion of weighing of the bale on the bale handler, and the bale handler is in a carry position of the plurality of positions to weigh the bale; determining the weighing of the bale is complete based on the first sensor signal; and in response to determining the weighing of the bale is complete, controlling the one or more actuators to transition the bale handler from the carry position to a discharge position of the plurality of positions to discharge the bale from the agricultural harvester.

### BRIEF DESCRIPTION OF THE DRAWINGS

These and other features, aspects, and advantages of the presently disclosed embodiments will become better understood when the following detailed description is read with reference to the accompanying drawings in which like characters represent like parts throughout the drawings.

FIG. 1 is a perspective view of an embodiment of an agricultural harvester having a baler.

FIG. 2 is a side schematic view of an embodiment of a bale handler system that may be employed within the agricultural harvester of FIG. 1.

FIG. 3 is a side schematic view of the bale handler system of FIG. 2, in which a bale handler of the bale handler system is in a home position.

FIG. 4 is a side schematic view of the bale handler system of FIG. 3, in which the bale handler is in a receiving position.

FIG. 5 is a side schematic view of the bale handler system of FIG. 3, in which the bale handler is in a carry position.

FIG. 6 is a side schematic view of the bale handler system of FIG. 3, in which the bale handler is in a discharge position.

FIG. 7 is a block diagram of an embodiment of a bale handler control system that may be employed within the bale handler system.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

In the following description, for the purposes of explanation, numerous specific details are set forth in order to provide a thorough understanding of embodiments of the present disclosure. It will be apparent, however, to one skilled in the art that embodiments of the present disclosure may be practiced without some of these specific details.

In current agricultural harvesters, the operator provides numerous manual inputs (e.g., through pressing buttons, moving levers, etc.) during long hours of operation, demanding attention and responsiveness from the operator. For example, the operator provides manual inputs to control the bale handler system to discharge each bale after the bale is wrapped, weighed, and prepared for discharge onto the field. While the bale handler system offers enhanced maneuverability and precision in handling heavy bales, the reliance on ongoing operator input may detract from the overall user experience. Thus, it is presently recognized that more efficient and user-friendly solutions that may reduce the possibility of operator fatigue and thereby increase harvesting efficiency are desired.

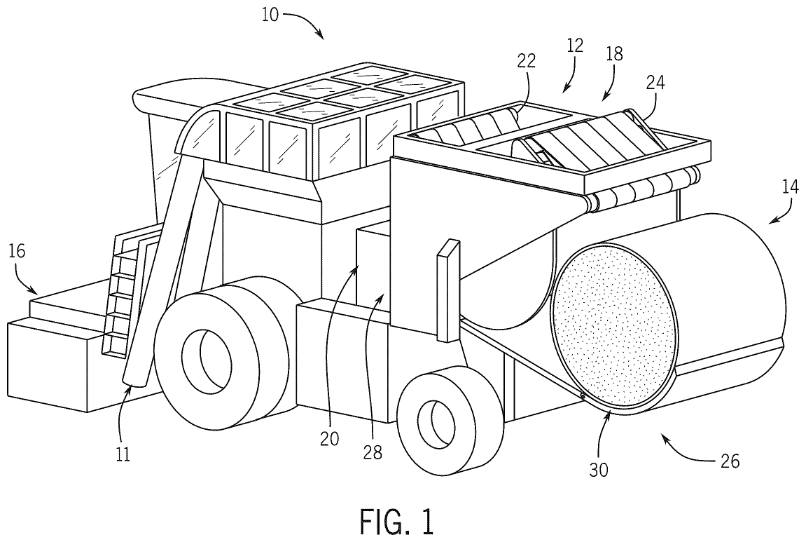

FIG. 1 is a perspective view of an embodiment of an agricultural harvester 10 (e.g., vehicle, harvester, etc.) having a baler 12. The agricultural harvester 10 harvests agricultural product (e.g., cotton) from a field and forms the agricultural product into bales 14 (e.g., agricultural bales 14). For example, the agricultural harvester 10 includes a header 16 having row units that harvest the agricultural product from the plants grown in the field. Additionally, an agricultural product transport assembly 11 of the agricultural harvester 10 may include an air-assisted conveying system that moves the agricultural product from the row units of the header 16 to the baler 12. The baler 12 is supported by and/or mounted within or on a chassis of the agricultural harvester 10. The baler 12 may form the agricultural product into round bales 14. However, in other embodiments, the baler 12 of the agricultural harvester 10 may form the agricultural product into square bales, polygonal bales, or bales of other suitable shape(s). After forming the agricultural product into a bale, a bale wrapping system 20 of the agricultural harvester 10 (e.g., baler 12) wraps the bale with a bale wrap to secure the agricultural product within the bale and to generally maintain a shape of the bale.

In the illustrated embodiment, the baler 12 includes a bale forming region 18 where the bale 14 is formed. The baler 12 also includes one or more main rollers 22 (e.g., first roller, second roller, third roller, fourth roller, fifth roller, sixth roller, etc.) disposed about the bale forming region 18. The baler 12 also includes a pendulum arm 24 used for ejection of the bale 14 into a bale handler system 26 for further handling. In certain embodiments, the baler 12 also includes a feeding system 28 that feeds the agricultural product into the bale forming region 18 and the bale wrapping system 20 wraps fully-formed bales 14.

Once the agricultural product is baled in the baler 12, the baler 12 (e.g., via a bale ejection system) may eject the bale into the bale handler system 26, which manages the discharge of the bale 14 at an appropriate location. The bale handler system 26 includes a bale handler 30 mounted on the rear of the agricultural harvester 10 to receive the bale 14 ejected from the baler 12, carry the bale 14 to a desired location, and discharge the bale 14 at the desired location. In certain embodiments, the bale handler 30 may assume different configurations during various phases of the discharge process. For example, the bale handler 30 may include an articulatable section articulatable via an actuator. As such, the bale handler 30 may maintain a first configuration (e.g., carry position as illustrated) to transport the bale 14 while supporting the bale 14 on the agricultural harvester 10. The bale handler 30 may transition to a second configuration (e.g., discharge position) to provide a discharge chute to guide the bale 14 down to the field.

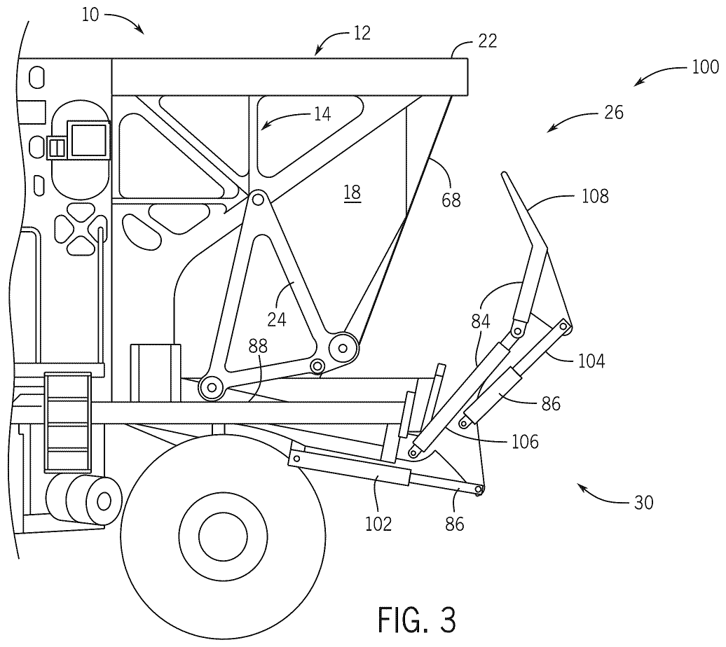

In certain embodiments, the bale handler system 26 may include a weighing system that measures the weight of the bale 14 and provides the measurement to the operator (e.g., through a digital display) before the bale 14 is discharged from the agricultural harvester 10. As discussed in detail below, once the weighing of the bale 14 is complete, the bale handler system 26 may automatically discharge the bale 14 without requiring any input from the operator. For example, a bale handler control system of the bale handler system 26 may automatically control the bale handler 30 to transition to a specific configuration to discharge the bale 14. In certain embodiments, the bale handler system 26 may automatically discharge the bale 14 based on a control scheme (e.g., a timing scheme). For example, the bale handler control system may begin the automatic discharge process after a lapse of a time interval (e.g., 0, 1, 2, 3, or more seconds) following the completion of the weighing. In certain embodiments, the bale handler control system may enable the operator to input and/or select the control scheme before field operation begins. As such, the operator may no longer provide a manual command each time a bale 14 is ready to be discharged during field operation. Various aspects of the automatic discharge process and the associated control scheme are discussed in further detail below with respect to FIGS. 3-7.

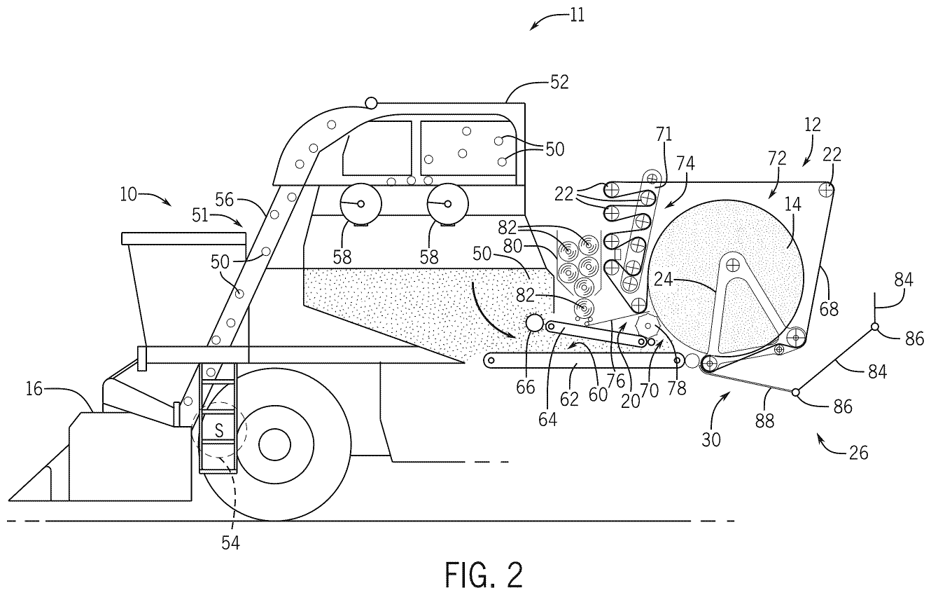

FIG. 2 is a side schematic view of an embodiment of a bale handler system 26 that may be employed within the agricultural harvester 10 of FIG. 1. As previously discussed, the header 16 of the agricultural harvester 10 includes row units that harvest the agricultural product 50 (e.g., cotton) from the field. Furthermore, the air-assisted conveying system 51 of the agricultural product transport assembly 11 moves the agricultural product 50 from the row units of the header 16 to an accumulator assembly 52. In the illustrated embodiment, the air-assisted conveying system 51 includes a conveying air source 54 outputs a conveying air flow through one or more ducts 56. Each duct 56 receives the agricultural product 50 (e.g., cotton) from the header 16, and the conveying air flow output by the conveying air source 54 drives the agricultural product 50 to move through the duct(s) 56 from the header 16 to the accumulator assembly 52. In the illustrated embodiment, the agricultural product transport assembly 11 includes augers 58 that distribute the agricultural product 50 (e.g., cotton) laterally across the accumulator assembly 52 (e.g., crosswise to the downward movement of the agricultural product through the accumulator assembly). In the illustrated embodiment, the agricultural product transport assembly 11 includes two augers 58. However, in other embodiments, the agricultural product transport assembly may include more or fewer augers (e.g., 0, 1, 3, 4, or more).

In the illustrated embodiment, a conveying system 60 of the agricultural product transport assembly 11 includes a first belt (e.g., belt) 62 moves the agricultural product 50 from the accumulator assembly 52 to the baler 12. The first belt 62 rotates in a first rotational direction to move an agricultural product engaging surface of the first belt 62 toward the baler 12. Furthermore, in the illustrated embodiment, the conveying system 60 includes a second belt 64 positioned on an opposite side of the agricultural product 50 from the first belt 62, and the second belt 64 cooperates with the first belt 62 to move the agricultural product 50 from the accumulator assembly 52 to the baler 12. Furthermore, in the illustrated embodiment, the conveying system 60 includes an agitation roller 66 positioned upstream of the second belt 64. The agitation roller 66 agitates the agricultural product 50 entering the pair of opposing belts, thereby enhancing the uniformity of the distribution of the agricultural product passing through the pair of opposing belts.

In the illustrated embodiment, the baler 12 includes multiple rollers 22 that support and/or drive rotation of one or more belts 68. For example, one or more rollers 22 engage the belt(s) 68, which enable the belt(s) 68 to move along the pathway defined by the rollers 22 and the bale 14. One or more rollers 22 are driven to rotate via a belt drive system (e.g., including electric motor(s), hydraulic motor(s), pneumatic motor(s), etc.). The belt(s) 68 circulate around the pathway defined by the rollers 22 and the bale 14. Movement of the belt(s) 68 captures agricultural product 50 from the conveying system 60 and draws the agricultural product 50 into a cavity 70, where the agricultural product 50 is gradually built up to form the bale 14.

In the illustrated embodiment, the baler 12 includes a tension arm 71 that establishes tension within the belt(s) 68. As the agricultural product 50 builds within the cavity 70, the agricultural product 50 applies a force to the belt(s) 68 that urges a first portion 72 of the belt(s) 68 surrounding the bale 14 to expand. Concurrently, the size of a second portion 74 (e.g., serpentine portion) of the belt(s) 68 is reduced. Accordingly, the second portion 74 of the belt(s) 68 provides the increasing belt length for the expanding first portion 72. In the illustrated embodiment, the second portion 74 of the belt(s) 68 is established by fixed rollers 22 (e.g., rollers fixed to a housing/frame of the baler 12) and rollers 22 coupled to the tension arm 71, which is pivotable relative to the fixed rollers 22 (e.g., relative to the housing/frame of the baler 12). Accordingly, as the agricultural product 50 builds within the cavity 70, the tension arm 71 is driven to rotate, thereby reducing the size of the second portion 74 and enabling the first portion 72 to expand.

Once the bale 14 reaches a desired size, a bale wrapping system 20 wraps the bale 14 with a bale wrap 76 to secure the agricultural product 50 within the bale 14 and to generally maintain a shape of the bale 14, such as the round shape in the illustrated embodiment. In other embodiments, the shape of the bale may be rectangular, polygonal, or another suitable shape. The bale wrap 76 may be fed into contact with the bale 14 using one or more rollers and/or one or more belts of a bale wrap feeding assembly. The roller(s) and/or the belt(s) drive the bale wrap 76 toward a starter roller 78. The starter roller 78 rotates to drive the bale wrap 76 into contact with the bale 14. The bale wrap 76 is captured between the bale 14 and the belt(s) 68. Accordingly, rotation of the bale 14 draws the bale wrap 76 around the bale 14, thereby wrapping the bale 14. After the bale 14 is wrapped, the bale 14 is ejected from the baler 12, and the process of forming a subsequent bale may be initiated.

In certain embodiments, during the harvesting process, the conveying system 60 and the baler 12 may be periodically activated to transfer the agricultural product 50 from the accumulator assembly 52 to the baler 12 and to form the bale 14. For example, as the agricultural harvester 10 traverses a field, the agricultural product 50 may accumulate within the accumulator assembly 52. After a selected duration, the conveying system 60 may be activated to transfer the agricultural product 50 from the accumulator assembly 52 to the baler 12. For example, the conveying system 60 may move the agricultural product 50 toward the baler 12 at a significantly faster rate than the air-assisted conveying system 51 moves the agricultural product 50 into the accumulator assembly 52. Concurrently with activation of the conveying system 60, the baler 12 may be activated to initiate the bale forming process, as described above. After another selected duration, the conveying system 60 and the baler 12 may be deactivated to enable the accumulator assembly 52 to collect additional agricultural product 50. In certain embodiments, the conveying system 60 and the baler 12 may be activated four or five times to enable the bale 14 to reach the desired size. As previously discussed, once the bale reaches the desired size, the bale wrapping system 20 wraps the bale 14 with the bale wrap 76. Because the conveying system 60 and the baler 12 are periodically activated, the agricultural harvester 10 may utilize less energy during the harvesting process (e.g., as compared to continuously operating the conveying system and the baler).

In the illustrated embodiment, the agricultural harvester 10 includes a bale wrap assembly storage compartment 80 that stores multiple bale wrap assemblies 82. In certain embodiments, each bale wrap assembly 82 includes a shaft and a bale wrap disposed about the shaft to form a roll of the bale wrap. However, in other embodiments, the shaft may be omitted, and the bale wrap may be arranged in a roll (e.g., with a hollow region at the center).

Furthermore, the agricultural harvester 10 (e.g., the bale wrapping system 20 of the agricultural harvester 10) includes a bale wrap feeding assembly that receives an active bale wrap assembly 82 from the bale wrap assembly storage compartment 80 and feeds the bale wrap 76 of the active bale wrap assembly 82 toward the bale 14 (e.g., toward the starter roller 78). The bale wrap feeding assembly includes one or more rollers and/or one or more belts driven by motor(s). The roller(s) and/or the belt(s) engage the bale wrap 76 and drive the bale wrap 76 toward the bale 14 as the roller(s) and/or the belt(s) are driven by the motor(s).

As previously discussed, once the bale 14 is wrapped via the bale wrapping system 20, the baler 12 may eject the wrapped bale 14 into the bale handler system 26 for further handling. The bale handler system 26 includes a bale handler 30 mounted on the rear of the agricultural harvester 10 to receive the bale 14 ejected from the baler 12, carry the bale 14 to a desired location, and discharge the bale 14 at the desired location.

In the illustrated embodiment, the bale handler 30 includes one or more articulatable sections 84 articulatable via one or more actuators 86 (e.g., hydraulic cylinders). By articulating the one or more articulatable sections 84, the bale handler 30 may transition among various configurations to manage the movement of the bale 14 during different phases of the discharge process. The one or more articulatable sections 84 may include top surfaces that are generally flat, enabling the bale 14 to roll on the surfaces while the surfaces are inclined. In certain embodiments, the bale handler 30 may include a fixed, slightly inclined guide section 88 attached between the baler 12 and the articulatable sections 84. As such, the bale 14 may be gently guided down onto the one or more articulatable sections 84 after being ejected from the baler 12.

In certain embodiments, the bale handler control system may, by controlling the one or more actuators 86, retract the bale handler 30 to extend generally upward into the illustrated configuration (e.g., home position) while no bale is in the bale handler system 26 to reduce the length of the agricultural harvester 10. Such configuration to keep the agricultural harvester 10 short may enhance stability and maneuverability during harvesting. In certain embodiments, the bale handler control system may, by controlling the one or more actuators 86, articulate the bale handler 30 to extend generally outwardly (e.g., to a receiving position) to prepare for receiving the bale 14 ejected from the baler 12. In certain embodiments, the bale handler control system may weigh the bale 14 ejected from the baler 12 on the bale handler 30 (e.g., while in a carry position) before discharging the bale 14 onto the field. In certain embodiments, after weighing, the bale handler control system may, by controlling the one or more actuators 86, articulate the bale handler 30 to extend toward the field (e.g., to a discharge position), creating a ramp that the bale 14 may roll down smoothly onto the ground.

As discussed in detail below, the bale handler control system may transition the bale handler among various configurations automatically, without any manual input from the operator (e.g., based on a programmable control scheme). The bale handler control system may determine the appropriate timing for transitioning the bale handler from a configuration to another configuration based on feedback obtain from the bale handler system 26, the baler 12, or any other systems of the agricultural harvester 10. For example, the bale handler control system may receive a signal indicative of the bale 14 forming in the baler 12 exceeding a certain size threshold, and begin transition the bale handler 30 from the home position to the receiving position to prepare for receiving the bale 14 in response to the signal. As another example, the bale handler control system, in response to determining the weight measurement of the bale 14 on the bale handler 30 is complete, may transition the bale handler 30 from the carry position to the discharge position to initiate discharging of the bale 14. Various aspects of the various configurations of the bale handler 30 are discussed in further detail below with respect to FIGS. 3-6.

FIG. 3 is a side schematic view of the bale handler system 26 of the agricultural harvester 10, in which the bale handler 30 is in a home position. The agricultural harvester 10 is substantially the same as discussed above with reference to FIGS. 1 and 2. For example, the bale handler system 26 and the baler 12 have the same components and functionality as described above with reference to FIGS. 1 and 2. Therefore, like elements are shown with like numbers.

As previously described, the agricultural harvester 10 may traverse the field to harvest the agricultural product. As the agricultural product is harvested, the baler 12 bales the harvested agricultural product 50 and wraps the complete bale with the bale wrap. The bale handler system 26 may automatically manage the bale discharge process without receiving manual input from the operator. Thus, the operator may focus on driving the agricultural harvester 10 without being distracted by the bale handler system 26 requesting the operator's confirmation to discharge every bale.

As previously described, the bale handler control system of the bale handler system 26 may control the configuration of the bale handler 30 by controlling the one or more actuators 86. In the illustrated embodiment, the one or more actuators 86 includes a first hydraulic cylinder 102 and a second hydraulic cylinder 104. However, in other embodiments, the one or more actuators 86 may include other suitable actuation device(s) (e.g., alone or in combination with the hydraulic cylinder), such as a pneumatic cylinder, an electric linear actuator, etc. The first hydraulic cylinder 102 may have a first end attached to the guide section 88 and a second end attached to a first articulatable section 106 (e.g., via a flange of the first articulatable section 106, as illustrated) of the one or more articulatable sections 84. The second hydraulic cylinder 104 may have a first end attached to the first articulatable section 106 and a second end attached to a second articulatable section 108 (e.g., via a flange of the second articulatable section 108, as illustrated). By adjusting the overall lengths of the first hydraulic cylinder 102 and the second hydraulic cylinder 104 (via controlling the flow of hydraulic fluid in and out of the cylinders 102 and 104), the bale handler control system may control the inclined angle of the first articulatable section 106 and the second articulatable section 108. Using the illustrated embodiment as an example, by extending the lengths of the first hydraulic cylinder 102 and the second hydraulic cylinder 104, the bale handler control system may gradually transition the bale handler 30 to the illustrated home position. Conversely, by shortening the lengths of the first hydraulic cylinder 102 and the second hydraulic cylinder 104, the bale handler control system may gradually transition the bale handler 30 to the discharge position.

As shown, the bale 14 is forming in the bale forming region 18 of the baler 12, and no bale is in the bale handler system 26. During this time, the bale handler control system may retract the bale handler 30 to extend generally upward into the home position, as shown, to establish the shortened length of the agricultural harvester 10. To transition the bale handler 30 to the illustrated home position, the bale handler control system may extend the first hydraulic cylinder 102 and the second hydraulic cylinder 104, thereby driving the first articulatable section 106 and the second articulatable section 108 toward the baler 12. In certain embodiments, the bale handler 30 may cover the rear portion of the baler 12 entirely or partially while in the home position, blocking the discharge pathway for the bale 14.

To facilitate automatic control of the bale handler 30, the bale handler control system may receive feedback from sensor(s) of the bale handler system 26, the baler 12, or any other interconnected system(s) of the agricultural harvester 10. The feedback may be sensor feedback obtained through one or more sensors disposed throughout the agricultural harvester 10 (e.g., one or more sensors may be weight/load sensor(s), speed sensor(s), position sensor(s), gyroscope(s), encoder(s), moisture sensor(s), temperature sensor(s), or any other suitable sensor(s) or combination of sensors. Based on the received feedback, the bale handler control system may monitor and assess operational conditions of the agricultural harvester 10 associated with the bale discharge process. Accordingly, the bale handler control system may adjust the configuration of the bale handler 30, enabling the bale handler to respond dynamically to changing operational conditions.

In some embodiments, the home position may be a default position for the bale handler 30, and the bale handler control system may maintain the bale handler 30 in the home position until initiation of the bale discharge process. The bale handler control system may initiate the bale discharge process in various ways. The bale discharge process may begin before the bale 14 is in the bale handler 30. For example, the bale handler control system may maintain the bale handler 30 in the home position until the bale handler control system receives a signal indicative of the bale 14 forming in the baler 12 exceeding a certain size threshold or a signal indicative of completion of the bale wrapping process. In response to receiving the signal, the bale handler control system may control the hydraulic cylinders to transition the bale handler 30 from the home position to the receiving position to prepare for receiving the bale 14.

In some embodiments, the bale handler control system may receive sensor feedback indicative of a variety of current operational conditions, and the bale handler control system may initiate the bale discharge process in response to determining the operational conditions are suitable (e.g., when the operational conditions meet respective criteria). For example, the bale handler control system may only initiate the bale discharge process in response to determining certain parameter(s) of the agricultural harvester 10, such as ground speed/acceleration, steering angle, inclination, location, or a combination thereof, are within threshold range(s) (e.g., such that the bale discharge process is initiated only while suitable conditions for extending the bale handler 30 are present). As another example, the bale handler control system may only initiate the bale discharge process in response to determining the operator is properly seated and secured in the cab. By way of further example, the bale handler control system may only initiate the bale discharge process in response to determining the agricultural harvester is in a harvesting mode (e.g., the conveying air source is operating, the row units of the header are operating, etc.).

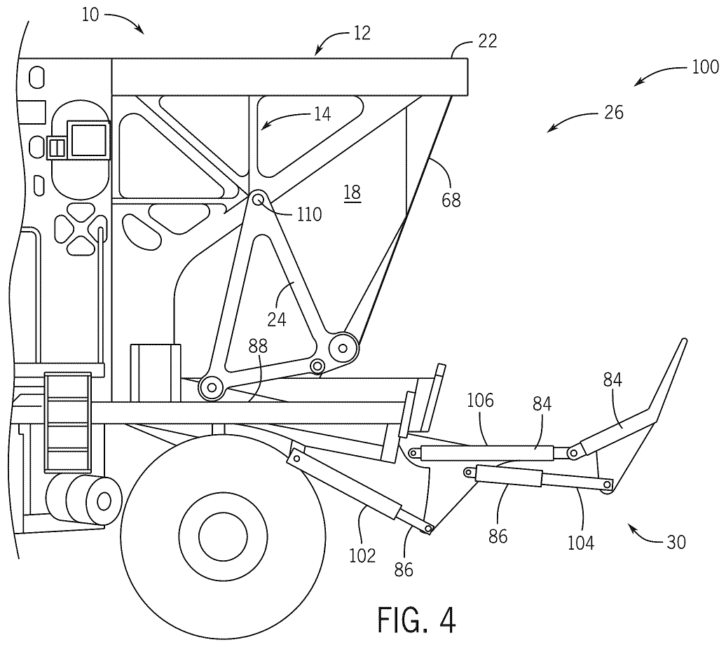

FIG. 4 is a side schematic view of the bale handler system 26, in which the bale handler 30 is in a receiving position. As shown, the bale 14 is still present in the bale forming region 18 of the baler 12, and no bale is in the bale handler system 26. The bale handler 30 has transitioned from the home position to the receiving position to prepare for receiving the bale 14 once ejected from the baler 12. To transition from the home position to the receiving position, the bale handler control system may, by controlling the first hydraulic cylinder 102 and the second hydraulic cylinder 104, articulate the bale handler 30 to extend generally outwardly. Accordingly, the bale handler control system may retract at least the first hydraulic cylinder 102 and, in certain embodiments, the second hydraulic cylinder 104, moving the first articulatable section 106 and the second articulatable section 108 away from the baler 12. In the receiving position, the bale handler 30 no longer covers the rear portion of the baler 12, thereby enabling the bale 14 to roll down along the guide section 88 and engage the first articulatable section 106 and the second articulatable section 108.

The bale handler system 26, while in the receiving position, may absorb kinetic energy of the bale 14 generated during the ejection of the bale 14. In the illustrated embodiment, the first articulatable section 106 is oriented generally parallel to the ground to create a flat buffer zone, whereas the second articulatable section 108 is oriented upwardly to retain the bale 14 within the bale handler 30. As such, the bale 14 may come to a gradual stop after being ejected from the baler 12.

In certain embodiments, the baler 12 may eject the bale 14 into the bale handler system 26 by driving the pendulum arms 24 to rotate upwardly around pivots 110. In doing so, the pendulum arms 24 move the belt(s) 68 upwardly, thereby opening a pathway from the baler 12 to the bale handler 30, which was previously blocked by the belt(s) 68. Once the bale 14 reaches a desired size and is wrapped, the bale 14 is ejected from the baler 12. The bale 14 may roll down along the guide section 88 and subsequently land on the first articulatable section 106. In certain embodiments, the baler 12 may, subsequently, drive the pendulum arms 24 around the pivots 110 back to the bale-forming position, thereby closing the pathway from the baler.

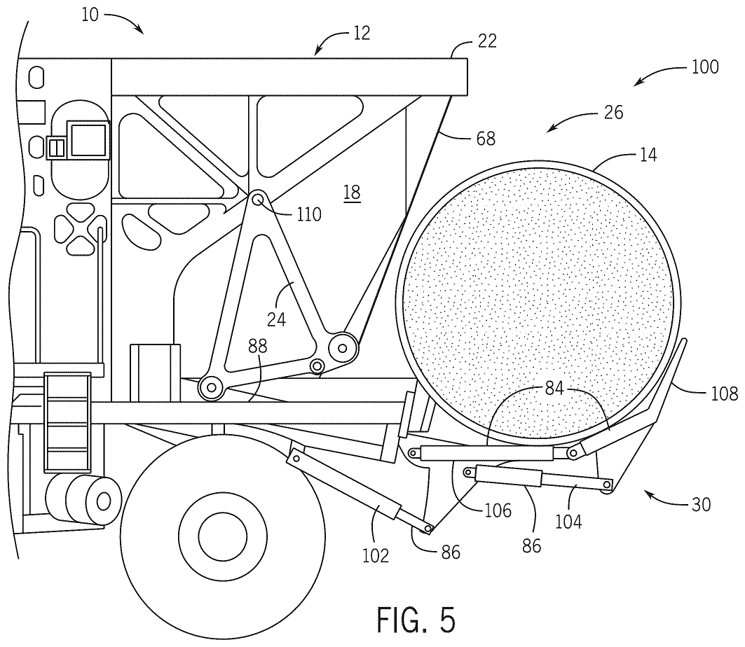

FIG. 5 is a side schematic view of the bale handler system 26, in which the bale handler 30 is in a carry position, in which the bale handler 30 is carrying the bale 14 after the bale 14 is ejected from the baler 12. While the bale handler control system may not necessarily articulate the first articulatable section 106 and the second articulatable section 108, the weight of the bale 14 may drive the bale handler 30 toward the ground. The first hydraulic cylinder 102 and the second hydraulic cylinder 104 may be driven to retract by the load applied by the bale 14, which increases the fluid pressure within the hydraulic cylinders 102 and 104.

As previously mentioned, in certain embodiments, the bale handler system 26 may include a weighing system that measures the weight of the bale 14. In the illustrated embodiment, the bale handler control system may measure the weight of the bale 14 based on measurements of the fluid pressure within the hydraulic cylinders (e.g., the first hydraulic cylinder 102 and the second hydraulic cylinder 104). For example, the weight of the bale 14 may be determined from a change in pressure measurements of the fluid pressure within the hydraulic cylinders as the baler transitions from the receiving position to the carry position.

Upon determining the weight of the bale, the bale handler control system may determine the weighing of the bale 14 is complete. In certain embodiments, the bale handler control system may determine that the weighing of the bale 14 is complete after a lapse of a time from ejecting the bale (e.g., based on an estimated weighing time). Additionally or alternatively, the bale handler control system may determine that the weighing of the bale 14 is complete after the pressure measurements have a time variance below a threshold. In certain embodiments, the bale handler control system may output a notification to the operator indicating the weighing of the bale 14 is completed. Further, the bale handler control system may output the measured weight of the bale 14 to a user interface, such as a display or other suitable output devices, thereby informing the operator of the bale weight.

In certain embodiments, the bale handler control system may also receive sensor feedback indicative of certain current operational conditions, and the bale handler control system may only proceed to discharge the bale 14 when the operational conditions are suitable (e.g., when the operational conditions meet respective criteria). For example, the bale handler control system may only proceed to discharge the bale 14 in response to determining certain parameter(s) of the agricultural harvester 10, such as ground speed/acceleration, steering angle, inclination, location, or a combination thereof, are within threshold range(s) (e.g., such that the bale discharge process is initiated only while suitable conditions for extending the bale handler 30 are present). As another example, the bale handler control system may only proceed to discharge the bale 14 in response to determining the operator is properly seated and secured in the cab. By way of further example, the bale handler control system may only proceed to discharge the bale 14 in response to determining the agricultural harvester is in a harvesting mode (e.g., the conveying air source is operating, the row units of the header are operating, etc.).

In response to determining weighing is complete and, in certain embodiments, determining operational condition(s) are suitable, the bale handler control system may proceed to the next phase of the bale discharge process automatically. For example, the bale handler control system may control the hydraulic cylinders to transition the bale handler 30 from the carry position to the discharge position to discharge the bale 14. In certain embodiments, the bale handler control system may output a second notification to the operator via the user interface indicating that the bale handler system 26 is proceeding to discharge the bale 14.

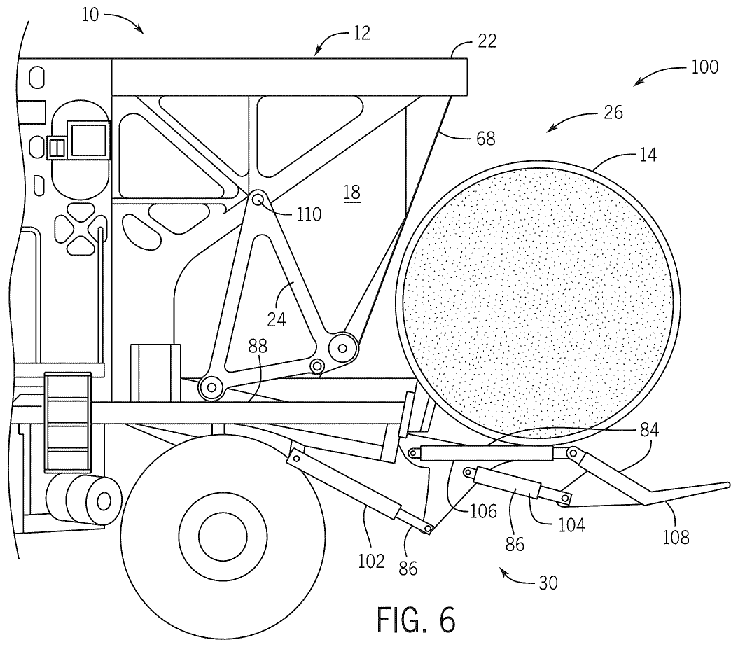

FIG. 6 is a side schematic view of the bale handler system 26, in which the bale handler 30 is in a discharge position. To transition from the carry position to the discharge position, the bale handler control system may, by controlling the first hydraulic cylinder 102 and the second hydraulic cylinder 104, articulate the bale handler 30 to extend toward the field in the illustrated discharge position, creating a ramp for the bale 14 to roll down smoothly onto the ground. As shown, the bale handler control system may retract the first hydraulic cylinder 102 and the second hydraulic cylinder 104, thereby driving the first articulatable section 106 and the second articulatable section 108 toward the ground. In certain embodiments, the bale handler control system may dynamically adjust the configuration of the bale handler 30 in the discharge position to establish the ramp that enables the bale 14 to be discharged smoothly. For example, the bale handler control system may determine desired degrees of articulation of the first articulatable section 106 and the second articulatable section 108 based on a distance between the bale handler 30 in the carry position and the ground. Additionally or alternatively, such adjustment may be determined based on the speed, acceleration, inclination, other suitable operational condition(s) of the agricultural harvester 10, or a combination thereof.

As the bale handler 30 extends toward the ground, the bale 14 may gradually roll down the ramp formed by the bale handler 30 and, eventually, land on the field. In certain embodiments, the operator may receive information associated with the bale discharge, such as an identification of the bale 14, a discharge location, and a discharge time, from the bale handler control system upon completion of the bale discharge process. The information may be saved in a storage service such that the discharged bale 14 may be traced back to its discharge location at a later time (e.g., for pickup).

The bale handler control system may determine that the bale discharge process is complete in response to determining pressure measurements of fluid pressure within the first hydraulic cylinder 102 and the second hydraulic cylinder 104 are below a threshold after a lapse of time from the transition to the discharge position. Upon completion of the bale discharge process, the bale handler control system may control the hydraulic cylinders to retract the bale handler 30 back to the home position. For example, the bale handler control system may extend the first hydraulic cylinder 102 and the second hydraulic cylinder 104, thereby driving the first articulatable section 106 and the second articulatable section 108 toward the baler 12.

While the bale handler control system may control the bale discharge process automatically without any manual input from the operator, the operator may manually override any control commands (e.g., via the user interface) during the bale discharge process. In certain embodiments, the automatic control of the bale discharge process may be temporarily suspended if operator intervention is detected. For example, the operator may observe an obstacle ahead of the agricultural harvester 10 that may cause the operator to perform certain maneuvers that may be unsuitable for discharging the bale 14. Accordingly, the operator may provide input to delay or pause the automatic bale discharge process. The operator may provide further input to resume the automatic bale discharge process at a more suitable location (e.g., where the obstacle is out of the path), thereby returning controls of the bale discharge process back to the bale handler control system. Furthermore, in certain embodiments, the operator may disengage the automatic control and operate the bale handler system manually (e.g., via the user interface).

In some embodiments, the operator may monitor the automatic bale discharge process through the user interface. The user interface may display information associated with the automatic bale discharge process. For example, the user interface may provide information, such as the characteristics (e.g., identification, size, location, measured weight) of an associated bale, current configuration of the bale handler 30, other information helpful for monitoring the automatic bale discharge process, or a combination thereof. As such, the operator may intervene in the automatic bale discharge process if desired. In certain embodiments, the bale handler control system may passively request operator input through the user interface. For example, while the automatic bale discharge is enabled, the user interface may provide an option for the operator to delay the discharge process. If the operator does not provide any manual input, the bale handler control system may continue the automatic bale discharge process. Conversely, while the automatic bale discharge process is disabled, the user interface may provide an option for the operator to resume the discharge process. If the operator does not provide any manual input, the bale handler system 26 may continue to operate in manual mode.

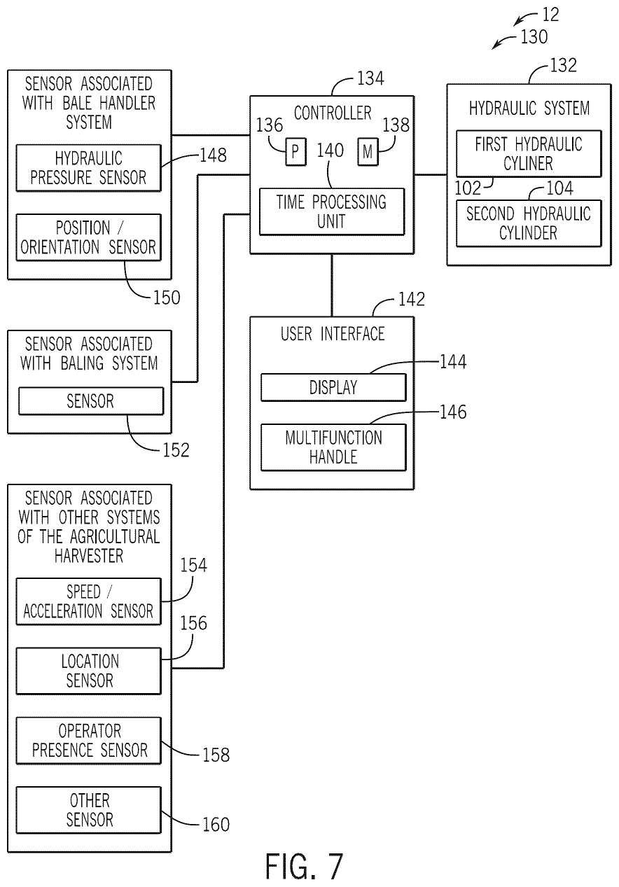

With the foregoing in mind, the following description is related to a bale handler control system of the bale handler system 26 that controls the bale discharge process as described herein. FIG. 7 is a block diagram of an embodiment of a bale handler control system 130 that may be employed within the bale handler system 26. As previously discussed, a hydraulic system 132 of the bale handler system 26, including the first hydraulic cylinder 102 and the second hydraulic cylinder 104, may transition the bale handler 30 among different configurations to enable automatic bale discharge. For example, the hydraulic system 132 may, by extending and/or retracting the first hydraulic cylinder 102 and the second hydraulic cylinder 104, control the bale handler 30 to transition between the carry position (e.g., to transport the bale 14 while retaining the bale 14) and the discharge position (e.g., to provide a discharge chute to guide the bale 14 down to the field). While the hydraulic system 132 includes the first hydraulic cylinder 102 and the second hydraulic cylinder 104, as disclosed above with reference to FIGS. 3-6, to transition the bale handler 30 among various configurations in certain embodiments, in other embodiments, the hydraulic system may include other and/or additional hydraulic cylinders to transition the bale handler among various configurations.

To facilitate control of the hydraulic system 132, the bale handler control system 130 includes a controller 134 to control (e.g., extend and retract) the hydraulic cylinders of the hydraulic system 132. For example, the controller 134 may control valves of the hydraulic system 132 to control hydraulic fluid flow to and from the respective hydraulic cylinders. As such, the hydraulic system 132 may drive the first articulatable section and the second articulatable section to move, thereby changing the configuration of the bale handler. The controller 134 is communicatively coupled to the valves of the hydraulic system 132.

In certain embodiments, the controller 134 is an electronic controller having electrical circuitry configured to control the hydraulic system 132. In the illustrated embodiment, the controller 134 includes a processor 136, such as a microprocessor, and a memory device 138. The controller 134 may also include one or more storage devices and/or other suitable components. The processor 136 may be used to execute software, such as software for controlling the hydraulic system 132, and so forth. Moreover, the processor 136 may include multiple microprocessors, one or more “general-purpose” microprocessors, one or more special-purpose microprocessors, and/or one or more application specific integrated circuits (ASICs), or some combination thereof. For example, the processor 136 may include one or more reduced instruction set (RISC) processors.

The memory device 138 may include a volatile memory, such as random access memory (RAM), and/or a nonvolatile memory, such as read-only memory (ROM). The memory device 138 may store a variety of information and may be used for various purposes. For example, the memory device 138 may store processor-executable instructions (e.g., firmware or software) for the processor 136 to execute, such as instructions for controlling the hydraulic system 132, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the hydraulic system 132, etc.), and any other suitable data.

In certain embodiments, the controller 134 includes a time processing unit 140 that monitors the passage of time. For example, the time processing unit 140 may time delays as disclosed above, such as time delays following the completion of the weighing to begin discharging the bale 14 (i.e., transitioning from the carry position to the discharge position), time delays following the completion of the bale discharge process to begin retracting the bale handler 30 (i.e., transitioning from the discharge position to the home position), and any other suitable time delays to ensure the automatic bale discharge process smoothly proceed.

In the illustrated embodiment, the bale handler control system 130 includes a user interface 142 communicatively coupled to the controller 134. The user interface 142 receives input from an operator and provides information to the operator. The user interface 142 may include any suitable output device(s) for presenting information to the operator, such as speaker(s), indicator light(s), other suitable output device(s), or a combination thereof. In the illustrated embodiment, the user interface 142 includes a display 144 that presents visual information to the operator. In certain embodiments, the display 144 may include a touchscreen interface that receives input from the operator. In addition, the user interface 142 may include any suitable input device(s) for receiving input, such as a keyboard, a mouse, button(s), switch(es), knob(s), other suitable input device(s), or a combination thereof. In the illustrated embodiment, the user interface 142 includes a multi-function handle 146 that the operator may use to interact with the controller 134. For example, the operator may overwrite certain control commands generated by the controller 134 by providing manual inputs via the multi-function handle 146. The operator may delay, pause, resume, or a combination thereof, the automatic bale discharge process, which is controlled by the controller 134, via the multi-function handle 146.

In the illustrated embodiment, the bale handler control system 130 includes one or more sensors communicatively coupled to the controller 134. The one or more sensors may be sensors associated with the bale handler system 26, sensors associated with the baler 12, sensors associated with other systems of the agricultural harvester 10, or any suitable combination of these sensors. The controller 134 may facilitate automatic control of the hydraulic system 132 to control the configuration of the bale handler 30 during operation. The sensors in the illustrated embodiments are merely exemplary. The bale handler control system 130 may include more or fewer sensors to monitor any components of the agricultural harvester 10 to provide input to the controller 134 for controlling the bale handler 30.

The sensors associated with the bale handler system 26 may include one or more hydraulic pressure sensors 148 that measure the hydraulic fluid pressure within the hydraulic cylinders. For example, as previously described, the controller 134 of the bale handler control system 130 may determine the weight of the bale on the bale handler based on difference in hydraulic pressure between the bale handler being in the receiving position and the bale handler being in the carry position, which is determined based on feedback from the hydraulic pressure sensors 148. In addition, the controller 134 may determine that the weighing of the bale 14 is complete based on sensor data obtained through the hydraulic pressure sensor 148 and, in response, control the hydraulic system 132 to discharge the bale 14. Additionally or alternatively, the sensors associated with the bale handler system 26 may include position/orientation sensors 150 that output sensor data indicative of a current configuration of the bale handler 30. The controller 134 may track the progress of the bale discharge process based on the sensor data received from the position/orientation sensors 150.

The sensors associated with the baler 12 may include one or more sensors 152 that monitor the progress of the baling process within the baler 12. As previously described, the controller 134 of the bale handler control system 130 may receive a sensor signal indicative of a size of the bale forming in the baler 12, and begin transition the bale handler 30 from the home position to the receiving position to prepare for receiving the bale 14 in response to the size of the bale exceeding a certain size threshold. Such sensor signals may originate from sensors (e.g., encoders) associated with the rollers 22 of the baler. Alternatively, the controller 134 of the bale handler control system 130 may receive a sensor signal indicative of completion of the bale wrapping process, and begin transition the bale handler 30 from the home position to the receiving position to prepare for receiving the bale 14 in response to such sensor signal. Such sensor signals may original from sensors associated with the roller(s) driving the bale wrap 76 and/or other components of the bale wrapping system 20.

The sensors associated with other systems of the agricultural harvester 10 may include speed/acceleration sensor(s) 154 that monitor the operating speed/acceleration of the agricultural harvester 10, location sensor(s) 156 (e.g., GPS sensor(s)) that monitor the location (e.g., location within a field) of the agricultural harvester 10, operator presence sensor(s) 158 that monitor operator presence within the cab of the agricultural harvester 10, and any other sensors 160 that may be suitable for monitoring parameters associated with the automatic bale discharge process. These sensors may generate operational parameters indicative of the operational conditions of the agricultural harvester 10. As previously described, in certain embodiments, the controller 134 of the bale handler control system 130 may only initiate the bale discharge process and/or begin discharging the bale in response to determining certain operational conditions meet respective criteria. For example, the controller 134 of the bale handler control system 130 may only initiate the bale discharge process and/or begin discharging the bale in response to determining the bale weighing process is complete and, in certain embodiments, the agricultural harvester 10 is performing a harvesting operation. The controller 134 may determine that the agricultural harvester 10 is performing the harvesting operation through various manner. For example, the controller 134 may made such determination based on sensor signals indicating that the agricultural harvester 10 is operating at a speed within a certain threshold range indicative of the agricultural harvester 10 performing the harvesting operation. Additionally or alternatively, the controller 134 may made such determination based on active operations of the air-assisted conveying system 51 (e.g., indicated by active air flow through the one or more ducts 56) and/or the row units of the header 16 (e.g., indicated by active movement of the agricultural product 50 through the one or more ducts 56). Other criteria to initiate and/or proceed with the bale discharge process may include receiving sensor signals indicative of a steering angle of the agricultural harvester 10 below a certain steering threshold and/or the operator is properly seated and secured in the cab.

While only certain features of the disclosure have been illustrated and described herein, many modifications and changes will occur to those skilled in the art. It is, therefore, to be understood that the appended claims are intended to cover all such modifications and changes as fall within the true spirit of the disclosure. It should be appreciated that any features shown and described with reference to FIGS. 1-7 may be combined in any suitable manner.

The techniques presented and claimed herein are referenced and applied to material objects and concrete examples of a practical nature that demonstrably improve the present technical field and, as such, are not abstract, intangible or purely theoretical.

What is claimed is:

1. A bale handler control system for a bale handler of an agricultural harvester, comprising:
a controller comprising a processor and a memory, wherein the controller is configured to:
control one or more actuators of the bale handler to discharge a bale from the agricultural harvester, wherein the one or more actuators drive one or more articulatable sections of the bale handler to establish a plurality of positions, by:
receiving at least one sensor signal, wherein the at least one sensor signal comprises a first sensor signal indicative of completion of weighing of the bale on the bale handler, and the bale handler is in a carry position of the plurality of positions to weigh the bale;
determining the weighing of the bale is complete based on the first sensor signal; and
in response to determining the weighing of the bale is complete, controlling the one or more actuators to transition the bale handler from the carry position to a discharge position of the plurality of positions to discharge the bale from the agricultural harvester.

2. The bale handler control system of claim 1, wherein the at least one sensor signal comprises a second sensor signal indicative of the agricultural harvester performing a harvesting operation.

3. The bale handler control system of claim 2, wherein the second sensor signal is indicative of:
a speed of the agricultural harvester;
an air-assisted conveying system of the agricultural harvester outputting an air flow;
one or more row units of the agricultural harvester harvesting an agricultural product;
or a combination thereof;
wherein the controller is configured to control the one or more actuators to transition the bale handler from the carry position to the discharge position in response to determining the weighing of the bale is complete and at least one the speed of the agricultural harvester is within a threshold range associated with the harvesting operation, the air-assisted conveying system is outputting the air flow, or the one or more row units are harvesting the agricultural product.

4. The bale handler control system of claim 1, wherein the controller is configured to control the one or more actuators of the bale handler by:
receiving a third sensor signal indicative of completion of discharge of the bale; and
in response to receiving the third sensor signal, controlling the one or more actuators to transition the bale handler from the discharge position to a home position of the plurality of positions to reduce a length of the agricultural harvester.

5. The bale handler control system of claim 1, wherein the controller is configured to control the one or more actuators of the bale handler by:
receiving a fourth sensor signal indicative of the bale forming in a baler exceeding a size threshold or a fifth sensor signal indicative of completion of wrapping of the bale, wherein the baler wraps the bale and ejects the bale from the baler to the bale handler; and
in response to receiving the fourth or fifth sensor signal, controlling the one or more actuators to transition the bale handler to a receiving position of the plurality of positions to receive the bale ejected from the baler.

6. The bale handler control system of claim 1, wherein the controller is configured to:
receive one or more manual inputs from an operator of the agricultural harvester indicative of manual intervention; and
in response to receiving the one or more manual inputs, control the one or more actuators of the bale handler based on the one or more manual inputs.

7. The bale handler control system of claim 1, wherein the one or more actuators comprise one or more hydraulic cylinders, and the controller is configured to determine the weighing of the bale is complete based on a pressure measurement of fluid pressure within the one or more hydraulic cylinders having a time variance less than a variance threshold.

8. A bale handler system of an agricultural harvester, comprising:
a bale handler comprising one or more actuators that drive one or more articulatable sections of the bale handler to establish a plurality of positions; and
a bale handler control system, comprising:
a controller communicatively coupled to the one or more actuators, wherein the controller comprises a processor and a memory, and the controller is configured to:
control one or more actuators of the bale handler to discharge a bale from the agricultural harvester by:
receiving at least one sensor signal, wherein the at least one sensor signal comprises a first sensor signal indicative of completion of weighing of the bale on the bale handler, and the bale handler is in a carry position of the plurality of positions to weigh the bale;
determining the weighing of the bale is complete based on the first sensor signal; and
in response to determining the weighing of the bale is complete, controlling the one or more actuators to transition the bale handler from the carry position to a discharge position of the plurality of positions to discharge the bale from the agricultural harvester.

9. The bale handler system of claim 8, wherein the at least one sensor signal comprises a second sensor signal indicative of the agricultural harvester performing a harvesting operation.

10. The bale handler system of claim 8, wherein the second sensor signal is indicative of:
a speed of the agricultural harvester;
an air-assisted conveying system of the agricultural harvester outputting an air flow;
one or more row units of the agricultural harvester harvesting an agricultural product;
or a combination thereof;
wherein the controller is configured to control the one or more actuators to transition the bale handler from the carry position to the discharge position in response to determining the weighing is complete and at least one the speed of the agricultural harvester is within a threshold range associated with the harvesting operation, the air-assisted conveying system is outputting the air flow, or the one or more row units are harvesting the agricultural product.

11. The bale handler system of claim 8, wherein the controller is configured to control the one or more actuators of the bale handler by:
receiving a third sensor signal indicative of completion of discharge of the bale; and
in response to receiving the third sensor signal, controlling the one or more actuators to transition the bale handler from the discharge position to a home position of the plurality of positions to reduce a length of the agricultural harvester.

12. The bale handler system of claim 8, wherein the controller is configured to control the one or more actuators of the bale handler by:
receiving a fourth sensor signal indicative of the bale forming in a baler exceeding a size threshold or a fifth sensor signal indicative of completion of wrapping of the bale, wherein the baler wraps the bale and eject the bale from the baler to the bale handler; and
in response to receiving the fourth or fifth sensor signal, controlling the one or more actuators to transition the bale handler to a receiving position of the plurality of positions to receive the bale ejected from the baler.

13. The bale handler system of claim 8, wherein the controller is configured to:
receive one or more manual inputs from an operator of the agricultural harvester indicative of manual intervention; and
in response to receiving the one or more manual inputs, control the one or more actuators of the bale handler based on the one or more manual inputs.

14. The bale handler system of claim 8, wherein the one or more actuators comprise one or more hydraulic cylinders, and the controller is configured to determine the weighing of the bale is complete based on a pressure measurement of fluid pressure within the one or more hydraulic cylinders having a time variance less than a variance threshold.

15. A method for controlling a bale handler of an agricultural harvester, comprising:
controlling, via a controller having a processor and a memory, one or more actuators of the bale handler to discharge a bale from the agricultural harvester, wherein the one or more actuators drive one or more articulatable sections of the bale handler to establish a plurality of positions, by:
receiving at least one sensor signal, wherein the at least one sensor signal comprises a first sensor signal indicative of completion of weighing of the bale on the bale handler, and the bale handler is in a carry position of the plurality of positions to weigh the bale;
determining the weighing of the bale is complete based on the first sensor signal; and
in response to determining the weighing of the bale is complete, controlling the one or more actuators to transition the bale handler from the carry position to a discharge position of the plurality of positions to discharge the bale from the agricultural harvester.

16. The method of claim 15, wherein the at least one sensor signal comprises a second sensor signal indicative of the agricultural harvester performing a harvesting operation.

17. The method of claim 15, wherein the second sensor signal is indicative of:
a speed of the agricultural harvester;
an air-assisted conveying system of the agricultural harvester outputting an air flow;
one or more row units of the agricultural harvester harvesting an agricultural product;
or a combination thereof;
wherein the controller is configured to control the one or more actuators to transition the bale handler from the carry position to the discharge position in response to determining the weighing of the bale is complete and at least one the speed of the agricultural harvester is within a threshold range associated with the harvesting operation, the air-assisted conveying system is outputting the air flow, or the one or more row units are harvesting the agricultural product.

18. The method of claim 15, comprising controlling the one or more actuators of the bale handler by:
receiving a third sensor signal indicative of completion of discharge of the bale; and
in response to receiving the third sensor signal, controlling the one or more actuators to transition the bale handler from the discharge position to a home position of the plurality of positions to reduce a length of the agricultural harvester.

19. The method of claim 15, comprising controlling the one or more actuators of the bale handler by:
receiving a fourth sensor signal indicative of the bale forming in a baler exceeding a size threshold or a fifth sensor signal indicative of completion of wrapping of the bale, wherein the baler wraps the bale and eject the bale from the baler to the bale handler; and
in response to receiving the fourth or fifth sensor signal, controlling the one or more actuators to transition the bale handler to a receiving position of the plurality of positions to receive the bale ejected from the baler.

20. The method of claim 15, comprising:
receiving one or more manual inputs from an operator of the agricultural harvester indicative of manual intervention; and
in response to receiving the one or more manual inputs, controlling, via the controller, one or more actuators of the bale handler based on the one or more manual inputs.
